(19) United States
(12) Patent Application Publication
(10) Pub. No.: US 2022/0262152 A1
(43) Pub. Date: Aug. 18, 2022

(54) METHOD FOR THE DIRECT STREAMING OF DIGITAL CONTENT USING UNIQUE IDENTIFICATION EMBEDDED TO AN IMAGE

(71) Applicant: Angelica Figueiredo White, Alpharetta, GA (US)

(72) Inventor: Angelica Figueiredo White, Alpharetta, GA (US)

(21) Appl. No.: 17/719,701

(22) Filed: Apr. 13, 2022

Related U.S. Application Data
(63) Continuation-in-part of application No. 14/537,888, filed on Nov. 10, 2014.
(60) Provisional application No. 63/174,368, filed on Apr. 13, 2021.

(51) Int. Cl. G06V 30/30; G06V 30/32; G06V 30/20

(52) U.S. Cl. CPC G06V 30/30; G06V 30/20; G06V 30/333

(57) ABSTRACT

This invention allows for the direct streaming of digital content from an image carrying an embedded unique identification that can be visible, partially visible or concealed, capable of being extracted using AI Imaging recognition and OCR technologies, inclusive those capable of reading concealed information using magnet ink or invisible ink.

### FIELD OF THE INVENTION

TECHNOLOGY, IMAGING ENCODING and DECODING OF DATA. This invention relates to the direct streaming of digital content over mobile device and mobile network using unique identification embedded to an image that can be extracted using Imaging Recognition and OCR technologies.

### BACKGROUND OF THE INVENTION

This invention seeks to provide a more aesthetically pleasant representation of a code information attached to products, labels, and packaging for facilitating the direct streaming of digital content using a unique identification embedded to an image, and extracted it using imaging recognition and OCR technologies.

The use of one-dimensional and two-dimensional optical character readers such as Barcode and QR Code has been widely used in the supply chain to track consumer goods and packages successfully. These technologies use the contrast of dark and lighter colors, mainly black and white, to encode data. Its use though in marketing is restricted mainly because this technology lacks the look appeal to consumers. This invention provides a more aesthetically pleasing representation of encoded data to luxury brands, marketing materials, consumer packaging, products, and digital and printed media, to list a few, to enable the direct recording and streaming of digital content.

A generally known method of reading a two-dimensional code includes steps of scanning an image of the two-dimensional code by means of an image input device, such as from phone camera and barcode scanners, and then detecting the position of the concerned two-dimensional code to read out content of the code. Most of these solutions relied on the basic technic of encoding data using dark and light contrasts for encoding binary data. This code when exposed to infrared light or LED lights reflect light back to a scanner or camera sensor, which generates an analog signal that is decoded into binary data “0” or “1”.

The adoption of two-dimensional code for marketing purposes has been its unattractive design, which makes it more fit for operational applications. The means of scanning a code is not something that comes naturally to consumers, though they are becoming more used with scanning using mobile phones. Poor ambient light can also impact the readability of such codes, making it more challenging for its adoption among consumers.

### BRIEF SUMMARY OF THE INVENTION

Accordingly, in view of above-described problems encountered in the related field, the objective of the present invention is to allow the direct streaming of digital content from an image carrying an embedded unique identification that can be visible, partially visible, or concealed, and capable of being extracted using Imaging Recognition and OCR technologies.

An image containing an visible or concealed embedded unique identification allowing the direct recording and streaming of digital content in this invention is called “ZARImage”.

A method and apparatus for direct streaming, showing or playing of digital content using unique identification embedded to an image via mobile devices and mobile networks, is disclosed.

In one embodiment, a product provider is provided with a unique identification embedded to an image that allows for the recording of digital contents to be associated with this unique identification. It also allows for the direct streaming of digital contents associated with this unique identification, directly from the cloud to the mobile device media player without intervening steps.

In another embodiment, a digital asset is provided with an embedded unique identification capable of recording digital contents to be associated with the embedded unique identification, which is also capable of direct streaming digital contents associated with the embedded unique identification, directly from the cloud to the mobile device media player without intervening steps.

A mobile user of an application powered by this technology, as the message creator, captures the artifact's image holding the unique identification or digital asset holding the unique identification and submit it to the Imaging Recognition engine running either on the mobile device or on the cloud. The unique identification data is extracted using Imaging Recognition and OCR technologies. The extracted unique identification is validated to where digital contents can be recorded to this unique identification using a variety of digital contents. The mobile user is allowed to create a message and select consumer engagement options to be available to users directly from digital content streaming on media player.

A mobile user of an application powered by this technology, as the message viewer, captures the artifact's image holding the unique identification or digital asset holding the unique identification and submit it to the Imaging Recognition engine running either on the mobile device or on the cloud. The unique identification data is extracted using Imaging Recognition and OCR technologies. The extracted unique identification is validated to see if digital contents are associated with this unique identification, and if digital content is associated then it automatically retrieves digital contents and initiated the direct streaming to mobile device medial player without intervening steps. The mobile app or device is responsible for handling the proper display of content.

The embedding of unique identification to the image can be done using AI imaging technologies for identifying the best graphical representation of unique identification on image without compromising its extraction and unique identification reliability. The unique identification embedding can also be done using special inks that allows for concealing information from human eye, such as invisible ink that exposed hidden information when exposed to UV blacklight and magnet induction inks that can be read using Magnetic Ink Character Recognition technologies.

The unique identification embedded to an image can a ZIPPYAR Code “ZARCode”, a Non-Fungible Token (“NFT”), but not limited to them.

### BRIEF DESCRIPTION OF THE SEVERAL VIEWS OF THE DRAWING

Features and advantages of the present invention will become apparent from the following description of pictures thereof, by way of example only, to the accompanying drawings, in which:

FIG. 1 shows the schematic diagram illustrating elements engaged in a code based digital content creation and delivery over a mobile device and mobile network where code is embedded to an image.

FIG. 2 shows examples of apparatus carrying unique identification embedded to an image in accordance this invention embodiment.

FIG. 3 show example of digital image or digital asset carrying unique identification embedded capable of the direct recording and streaming of digital contents in accordance this invention embodiment.

FIG. 4 shows a workflow diagram for digital content creation using unique identification embedded to an image as presented in this invention

FIG. 5 shows a workflow diagram for digital content viewing using unique identification embedded to an image as presented in this invention

FIG. 6 shows a potential illustration of a unique identification inserted, embedded, or concealed to an image, capable of being extracted using imaging recognition technologies, invisible ink and magnetic ink character recognition technologies.

### DETAILED DESCRIPTION OF THE INVENTION

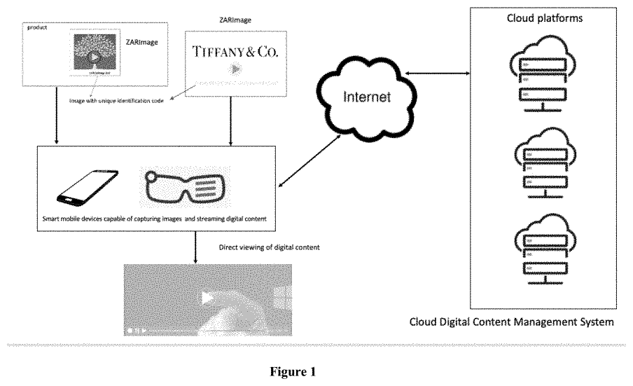

FIG. 1 shows the schematic diagram illustrating elements engaged in a code based digital content creation and delivery over a mobile device and mobile network where code is embedded to an image. In this figure the image with embedded unique identification can be associated with a physical product or be a digital asset. The mobile device capable of capturing these images and submitting them to a process for extracting the unique identification, that can be done on the mobile device or on the cloud using AI imaging recognition, Invisible Ink and Magnetic Ink Character Recognition technologies. The extracted unique identification being validated to allow either the direct recording or the direct streaming of digital contents to the mobile device media player without intervening steps.

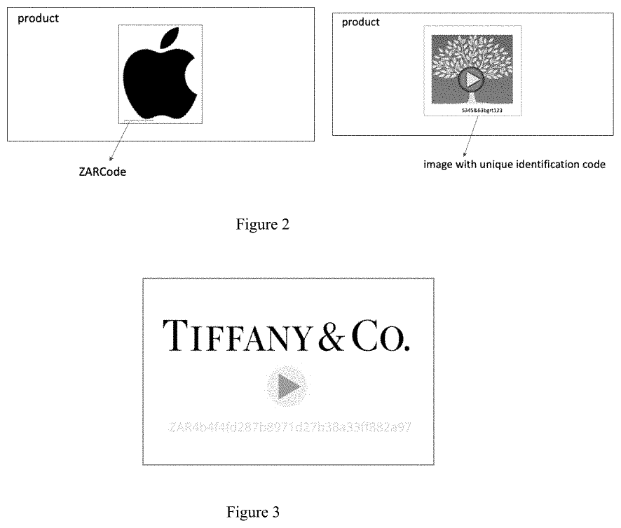

FIG. 2 shows examples of product apparatus carrying unique identification embedded to an image, ZARImage, in accordance this invention embodiment. The unique identification represented using, but not limited to, ZARCode and NFT technologies.

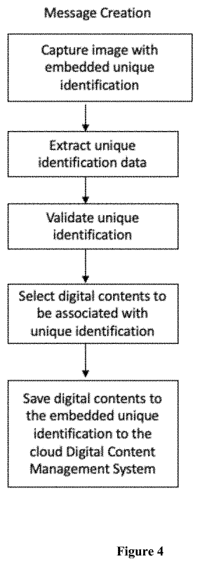

FIG. 3 show example of a digital asset, in this case an image, carrying an embedded unique identification to allow the direct recording and streaming of digital contents to be associated with this digital asset. The unique identification represented using, but not limited to, ZARCode and NFT technologies.

FIG. 4 shows a workflow diagram for digital content creation using unique identification embedded to an image as presented in this invention, where 1) Capture image with embedded unique identification; 2) Extract unique identification data; 3) Validate unique identification; 4) Select digital contents to be associated with unique identification; 5) Save digital contents to the embedded unique identification to the cloud Digital Content Management System.

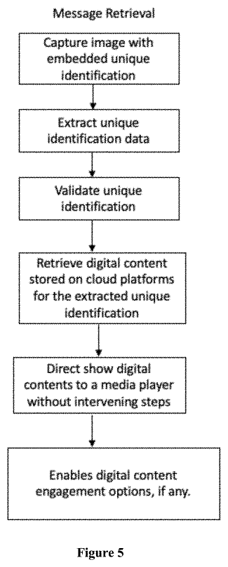

FIG. 5 shows a workflow diagram for digital content viewing using unique identification embedded to an image as presented in this invention, where 1) Capture image with embedded unique identification; 2) Extract unique identification data; 3) Validate unique identification; 4) Retrieve digital content stored on cloud platforms for the extracted unique identification; 5) Direct show digital contents to a media player without intervening steps; 6) Enables digital content engagement options, if any.

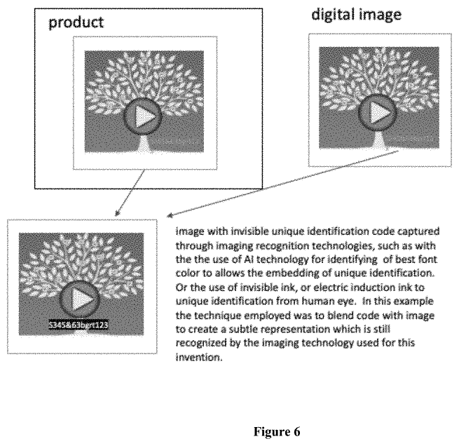

FIG. 6 shows a potential illustration of a unique identification concealed on an image, capable of being extracted using imaging recognition technologies powered by AI, invisible ink, or magnetic induction character recognition technologies. ZARImage with invisible or concealed unique identification code may used AI to identify the best font color to allows concealing of data without impacting the reliability of information when extracted. It can also use invisible ink to hide unique identification that can be extracted when exposed to UV lights, known as blacklights. It can also be hidden using magnetic induction inks and extracted using Magnetic Character Reading Technologies. An invisible embedding of unique identification to an image is not visible to the naked eye. In this example the technique employed was to blend code with image to create a subtle representation which is still recognized by the imaging technology used for this invention.

What is claimed is:

1. A method for facilitating digital content creation and digital content direct streaming from an image embedded with unique identification, comprising:
a method operatively hosted on a mobile device, the mobile device comprising at least one mobile device processor operatively connected to at least one cloud digital content management system via a mobile telecommunication network, wherein the at least one mobile device processor is configured to:
capture image with embedded unique identification and extracting unique identification;
validating unique identification to allow the recording and direct streaming of digital contents;
creating digital content and associating digital content with extracted unique identification;
obtaining digital content from the at least one cloud digital content management system upon the extraction and validation of unique identification;
directly playing the digital content obtained from the at least one cloud digital content management system via the mobile telecommunication network upon the reading of the unique identification.

2. The method in accordance with claim 1, wherein the at least one mobile device processor is configured for capturing the image with embedded unique identification and extracting the unique identification using either AI imaging recognition, optical character recognition technologies, inclusive those reading information printed using invisible ink or magnetic induction inks;

3. The method in accordance with claim 1, wherein image embedded with unique identification can be associated with a product apparatus or a digital asset;

4. The method in accordance with claim 1, wherein the unique identification embedded to an imagine can be a non-fungible token;
